(19) United States
(12) Patent Application Publication
(10) Pub. No.: US 2015/0161494 A1
(43) Pub. Date: Jun. 11, 2015

(54) INFORMATION PROCESSING APPARATUS, CONTROL METHOD, AND RECORDING MEDIUM

(71) Applicant: CANON KABUSHIKI KAISHA, Tokyo (JP)

(72) Inventor: Tetsu Oishi, Yokohama-shi (JP)

(21) Appl. No.: 14/563,726

(22) Filed: Dec. 8, 2014

(30) Foreign Application Priority Data
Dec. 10, 2013 (JP) 2013-254749

(51) Int. Cl. G06K 15/00; G06K 15/02

(52) U.S. Cl. CPC G06K 15/4065; G06K 15/1885

(57) ABSTRACT

An information processing apparatus is configured to receive data on which a printing area and a paper area different from the printing area are set, identify a type of an apparatus for printing the received data, and determine a paper size used for printing using the printing area or the paper size using the paper area based on the identified type of the printing apparatus.

### BACKGROUND OF THE INVENTION

1. Field of the Invention

The present invention relates to an information processing apparatus, a control method, and a recording medium.

2. Description of the Related Art

A portable document format (PDF) includes parameters such as a MediaBox, a CropBox and others. In printing with a conventional application and printer driver, a user has been able to specify a printing area, a printing size, and equal-magnification and scaling printing while confirming a preview.

In recent years, an electronic document file (also referred to as PDF or rendering data) specifying the MediaBox or the CropBox has been increasingly input in the form of printing attached data, which is called mail print, and also in the form of directly sending data to a printing apparatus without via a driver, which is called DirectPrint. The mail print is provided as a Web service. Japanese Patent Application Laid-Open No. 2012-084176 discusses a technique of using the MediaBox or the CropBox and executing print.

The technique discussed in Japanese Patent Application Laid-Open No. 2012-084176 does not take into consideration the use of the MediaBox and the CropBox switched in units of pages. In other words, switching a printing area in units of pages is not taken into consideration. Moreover, Japanese Patent Application Laid-Open No. 2012-084176 is not considering switching a method for determining a paper size depending on a printing apparatus.

### SUMMARY OF THE INVENTION

An information processing apparatus of the present invention includes a reception unit configured to receive data on which a printing area and a paper area different from the printing area are set, an identification unit configured to identify a type of an apparatus for printing the data received by the reception unit, and a first determination unit configured to determine a paper size used for printing using the printing area or the paper size used for printing using the paper area based on the identified type of the printing apparatus.

Further features of the present invention will become apparent from the following description of exemplary embodiments with reference to the attached drawings.

### BRIEF DESCRIPTION OF THE DRAWINGS

FIGS. 1A, 1B, and 1C illustrate document information to be printed by an information processing apparatus and output states.

FIG. 2 illustrates the configuration of a printing system according to the present exemplary embodiment.

FIG. 3 is a block diagram illustrating the hardware configuration of a server apparatus.

FIG. 4 is a block diagram illustrating the configuration of the modules of the printing system illustrated in FIGS. 1A, 1B, and 1C.

FIG. 5 is a flow chart illustrating a data process in the information processing apparatus.

FIG. 6 is a flow chart illustrating a data process in the information processing apparatus.

FIG. 7 is a flow chart illustrating a data process in the information processing apparatus.

FIG. 8 is a flow chart illustrating a data process in the information processing apparatus.

FIG. 9 is a flow chart illustrating a data process in the information processing apparatus.

FIG. 10 illustrates a positional relationship between a MediaBox MB and a CropBox CB.

FIG. 11 is a flow chart illustrating a data process in the information processing apparatus.

FIG. 12 is a flow chart illustrating a data process in the information processing apparatus.

FIGS. 13A, 13B, and 13C are diagrams illustrating a process for determining the printing area in the information processing apparatus.

### DESCRIPTION OF THE EMBODIMENTS

Various exemplary embodiments, features, and aspects of the invention will be described in detail below with reference to the drawings.

[Description of System Configuration]

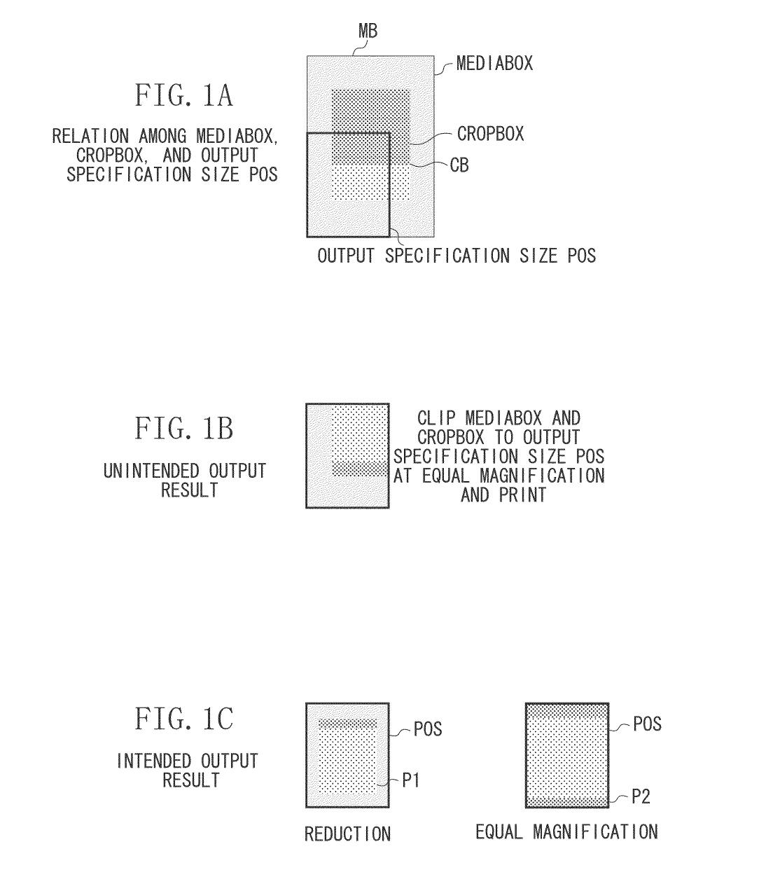

The following describes, with reference to FIGS. 1A, 1B, and 1C, a relation among the MediaBox and the CropBox of the PDF and an output specification size in the document, particularly, the PDF format file, to be processed in the printing system according to a first exemplary embodiment, as well as a user's unintended output, and a user's intended output. In this example, the printing area and the size of printing paper are automatically determined in the printing system, particularly in a Web service server. Automatic determination of the printing area and the like to be described in detail in the present exemplary embodiment is similarly feasible even if the automatic determination is made not in the Web service server, but inside the printing apparatus or in a cloud.

FIGS. 1A, 1B, and 1C illustrate document information to be printed by the information processing apparatus according to the present exemplary embodiment and output states. The MediaBox MB and the CropBox CB are specified as page information in the portable document format (PDF). At the time of printing, an output size POS for printing is also specified separately from the PDF specifications. Alternatively, the output specification size POS can be previously specified in the printing apparatus. The DirectPrint does not have a system for separately sending print setting information by a Ticket or the like, so that the DirectPrint operates in a default setting or setting of the printing apparatus, in relation to the print setting (refer to FIG. 1A).

In this connection, as an example, the MediaBox MB and the CropBox CB are cut at the equal magnification to come in the output specification size POS and is printed as illustrated in FIG. 1B. If confirmation is not performed in preview, an unintended output illustrated in FIG. 1B can be acquired. In such a case, the whole print is reduced to the output specification size or only the CropBox part is printed in a print form as illustrated in FIG. 1C. Examples of output results that the user intends are illustrated in outputs P1 and P2 in FIG. 1C.

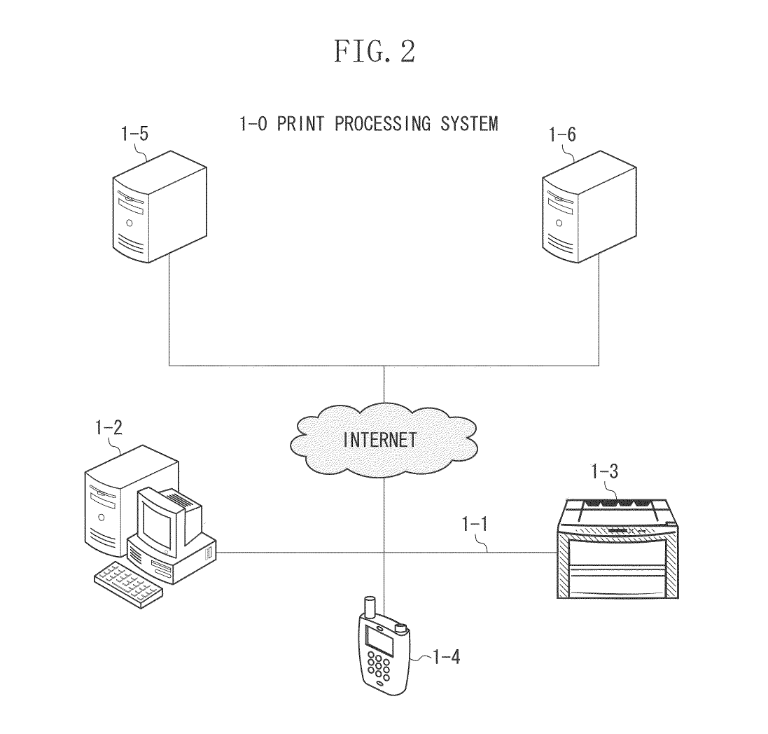

FIG. 2 illustrates the configuration of a printing system according to the present exemplary embodiment. In FIG. 2, a printing system 1-0 includes a client computer 1-2, a printing apparatus 1-3, and a mobile terminal 1-4 such as a cellular phone or a tablet terminal. Such devices are connected with one another via a network 1-1 which is connected to the Internet.

The printing system 1-0 includes a Web application server group 1-5. The server group 1-5 may be configured with a single server or a group of a plurality of servers. The printing system 1-0 may include an application service 1-6. The application service 1-6 is a print-on-demand (POD) server or a mail server, for example, and may be configured with a single server or a plurality of servers. The application service 1-6 connects the Web application server group 1-5 with the client computer 1-2 and the mobile terminal 1-4. The processing of print instruction will be described below. The client computer 1-2 (or the mobile terminal 1-4) notifies the Web application server group 1-5 of the rendering data specified by the user and an output destination printer. The Web application server group 1-5 determines a printing area and a size of a printing paper for the rendering data by the processing to be described below, generates print data based on a file to be printed, and transmits the print data to the printer 1-3. If the user selects a file in an application service group as rendering data, specifies a printer and gives an instruction to perform printing, a printing area and a size of a printing paper for the rendering data specified by the user are determined by the processing to be described below. The Web application server group 1-5 transmits the print data to the specified printer. A removal media such as a universal serial bus (USB) memory is attached to the printer 103. The rendering data are selected on the operation panel of the printer 103, and the Web application server group 1-5 may be instructed to perform printing. In this case, the printer 1-3 notifies the Web application server group 1-5 of the rendering data and the printing area, and the size of the printing paper for the rendering data are determined by the processing to be described below. The Web application server group 1-5 generates the printing data based on the determined printing area and size of the printing paper and transmits the printing data to the printer 1-3.

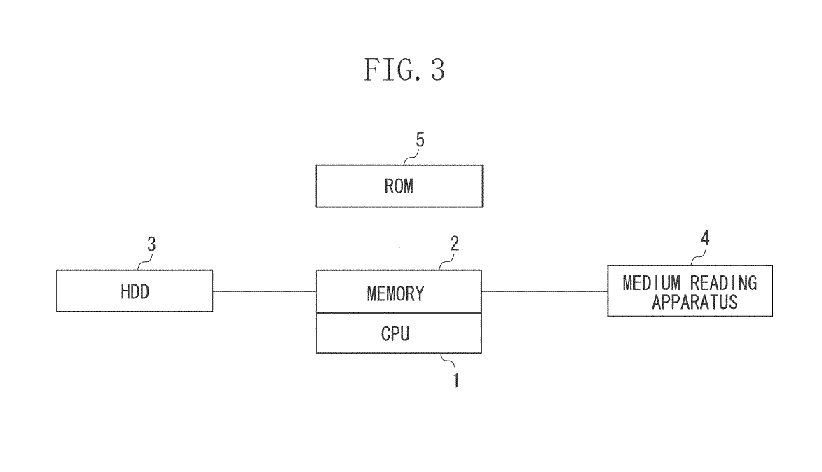

FIG. 3 is a block diagram illustrating the hardware configuration of the server apparatus according to the present exemplary embodiment. This example illustrates a configuration of the Web application server group 1-5 which employs the automatic determination of the printing area and the size of the printing paper.

In FIG. 3, a central processing unit (CPU) 1 performs various data processes. A memory 2 stores data read and written by the CPU 1. A hard disk drive (HDD) 3 stores various data. A medium reading apparatus 4 reads data from a read only memory (ROM) 5 such as a compact disk (CD)-ROM or a memory card connected to the system. Even if the apparatuses are connected via the network, the present invention can be applied.

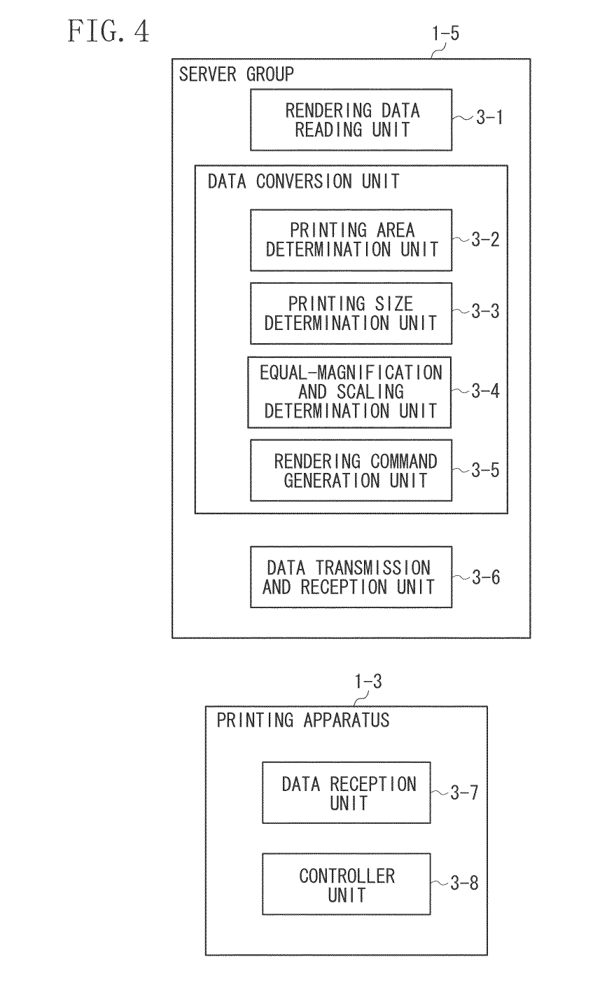

FIG. 4 is a block diagram illustrating the configuration of the modules of the printing system illustrated in FIG. 2. This example illustrates a configuration of Web application server group 1-5 and the printing apparatus 1-3. In FIG. 4, a rendering data reading unit 3-1 receives the rendering data and generates a rendering instruction. The rendering data uses the PDF as an example, but any data may be used provided that data specifying a bounding box is used. A printing area determination unit 3-2 determines the printing area from information about an output destination, a print purpose, and a positional relationship between the MediaBox and the CropBox.

A printing size determination unit 3-3 determines the size of a printing paper from information about the printing area and a support paper for the output destination. An equal-magnification and scaling determination unit 3-4 determines whether to perform equal-magnification and scaling printing from information about the printing area, the size of the printing paper, and the print purpose. A rendering command generation unit 3-5 generates a rendering command from the rendering instruction. A data transmission and reception unit 3-6 transmits/receives data to/from the printing apparatus.

The portions 3-1 to 3-6 illustrated in FIG. 4 can be realized by software in collaboration with the foregoing CPU 1, the memory 2, the HDD 3, the medium storage apparatus 4, and the ROM 5. However, the present invention is not limited to the software. Each portion may also be hardware logic.

In the printing apparatus 1-3, a data reception unit 3-7 of the printing apparatus receives the rendering command generated by the Web application server group 1-5. A controller unit 3-8 interprets the rendering command, converts the command into a binary image, and outputs the binary image to a print engine. The portions 3-7 and 3-8 illustrated in FIG. 4 can be realized by software in collaboration with the CPU, the memory, the HDD, and the ROM in the printing apparatus. However, the present invention is not limited to the software. Each portion may also be hardware logic.

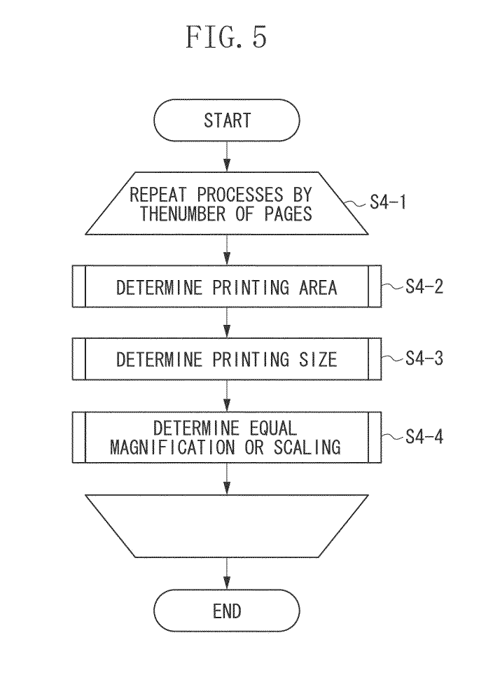

FIG. 5 is a flow chart illustrating a data process in the information processing apparatus according to the present exemplary embodiment. This example illustrates a process for automatically determining a printing area and a size of a printing paper performed by the data conversion unit illustrated in FIG. 4. The CPU 1 of the server apparatus illustrated in FIG. 3 loads the module illustrated in FIG. 4 into the memory 2, and execute to realize each step. The above process will be described below with the module illustrated in FIG. 4 as a main subject. In the present exemplary embodiment, the server apparatus receives the rendering data (a PDF document, for example) in which the printing area and the paper area are set to the page information such that they are different from each other, and thereby, the process is started. The above data can be acquired from various destinations. There may be various data processing forms depending on environment using the printing system. The rendering data is transmitted from the information processing apparatus operated by the user to a specific server apparatus and the print data may be transmitted from the server apparatus to a specific printing apparatus. Alternatively, it is assumed that the user uses a cloud service to transmit print data to a specific printing apparatus. The present exemplary embodiment is applicable to any form.

In step S4-2, the printing area determination unit 3-2 determines the printing area from information about an output destination, a print purpose, and a positional relationship between the MediaBox and the CropBox. In step S4-3, the printing size determination unit 3-3 determines the size of a printing paper from information about the printing area and a support paper at the output destination. In step S4-4, the equal-magnification and scaling determination unit 3-4 determines whether to perform equal-magnification and scaling printing from information about the printing area, the size of the printing paper, and the print purpose. In step S4-1, these processes are repeated the number times corresponding to required pages.

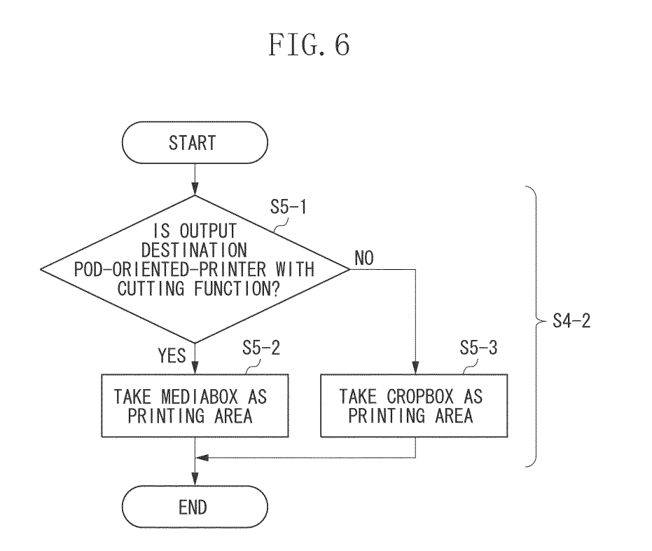

FIG. 6 is a flow chart illustrating a data process in the information processing apparatus according to the present exemplary embodiment. This example illustrates a detailed process for determining the printing area from information about the output destination in step S4-2 illustrated in FIG. 5. In step S5-1, the printing area determination unit 3-2 determines whether the destination to which the rendering data are output is a POD oriented printer which can execute cutting-out. If the destination to which the rendering data are output is a POD oriented printer having a cutting-out function (YES in step S5-1), in step S5-2, the printing area determination unit 3-2 takes the MediaBox as the printing area and the processing ends.

If the printing area determination unit 3-2 determines that the destination to which the rendering data are output is not a POD oriented printer having a cutting-out function (NO in step S5-1), in step S5-3, the printing area determination unit 3-2 takes the CropBox as the printing area and the processing ends. A printer different from the POD oriented printer is an office or a consumer oriented printer, for example.

Thus, in the present exemplary embodiment, a printing purpose and an application can be presumed from information about the destination to which the rendering data are output, so that the printing area can be set according to each printing purpose and the application. Since the user often performs setting for the POD oriented printer by selecting the MediaBox, it is desirable to take the MediaBox as the printing area. This is because additional information such as a register mark is often included outside the CropBox in the POD oriented printer for a cutting-out process. For this reason, in order to perform printing by including a register mark, if it is determined that the output destination is the POD oriented printer, the MediaBox is taken as the printing area.

On the other hand, the office and consumer oriented printers take the CropBox as the printing area according to the output of an application which is a rendering reference. This is because additional information rarely exists outside the CropBox in an office.

Information about the destination to which the rendering data are output is transferred from the client computer 1-2 or the mobile terminal 1-4 to the Web application server group through a user interface (UI) or a Ticket (setting file) at the time of printing. If the system is not provided with a setting unit such as the DirectPrint, the Web application server group can previously determine a printer as the output destination.

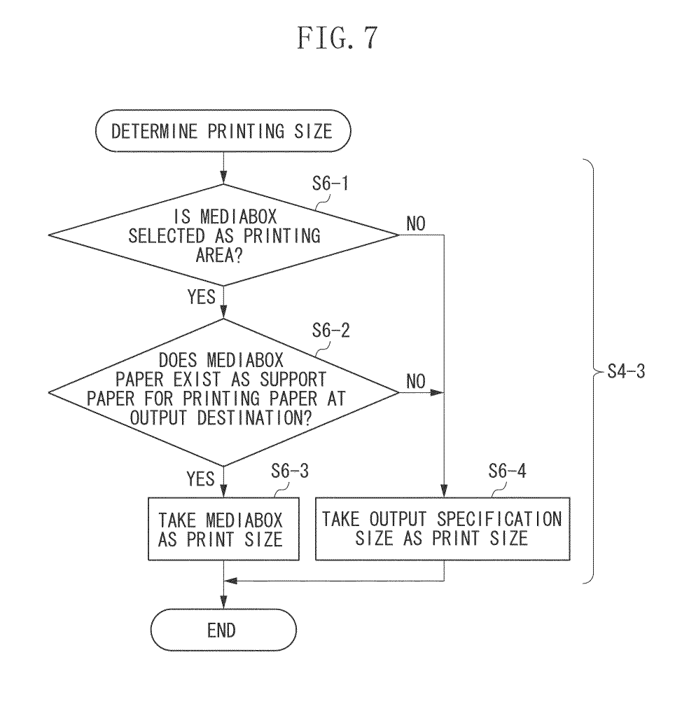

FIG. 7 is a flow chart illustrating a data process in the information processing apparatus according to the present exemplary embodiment. This illustrates in detail, as an example of step S4-3 illustrated in FIG. 5, a process for determining the size of a printing paper from information about the printing area and a support paper at the output destination.

In step S6-1, the printing size determination unit 3-3 determines whether the MediaBox illustrated in FIGS. 1A, 1B, and 1C is selected as the printing area. In step S6-2, the printing size determination unit 3-3 determines whether paper for the MediaBox MB exists as the support paper in the printing apparatus of the output destination. If the printing size determination unit 3-3 determines that paper for the MediaBox MB exists as the support paper in the printing apparatus of the output destination (YES in step S6-2), in step S6-3, the printing size determination unit 3-3 determines the MediaBox MB as the size of a printing paper.

If the printing size determination unit 3-3 determines that both of steps S6-1 and S6-2 are negative (NO in step S6-1 and S6-2), in step S6-4, the printing size determination unit 3-3 determines an output specification size as the size of a printing paper and the processing ends.

It is assumed that the output specification size is transferred from the client computer 1-2 or the mobile terminal 1-4 to the Web application server group through the UI or the Ticket (setting file) at the time of printing. If the system is not provided with a setting unit such as the DirectPrint, it is also assumed that the Web application server group previously determines the output specified size. The user specifies the MediaBox or the CropBox as the output specified size.

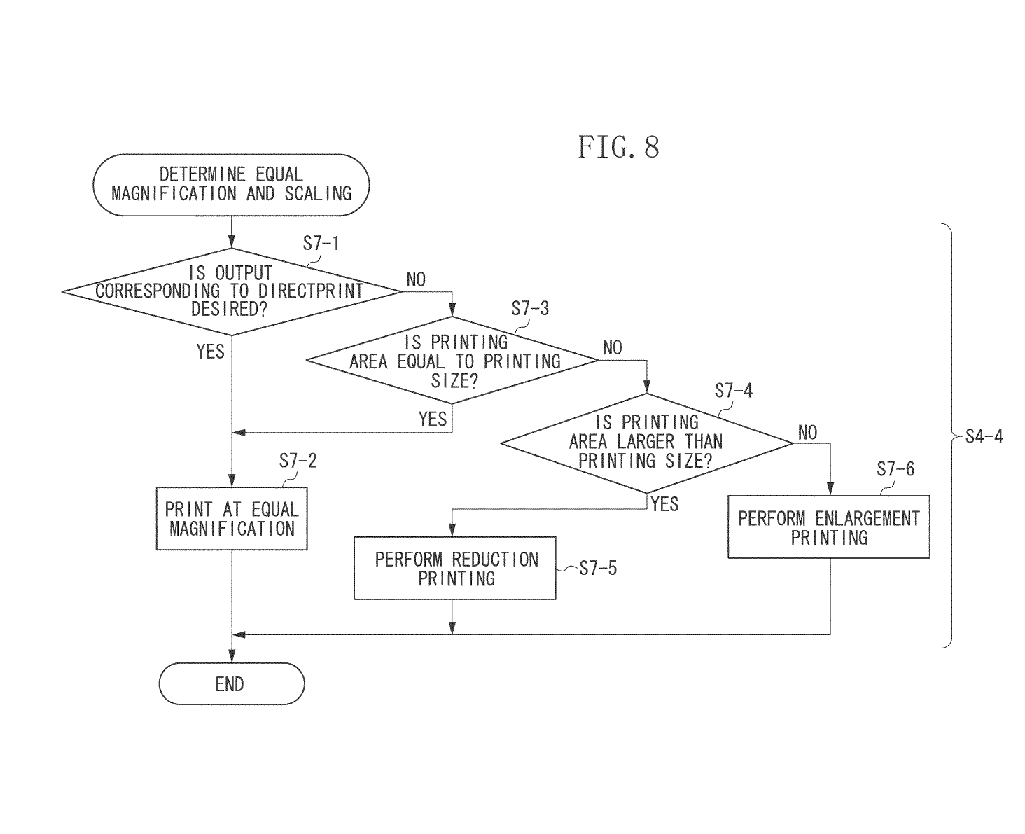

FIG. 8 is a flow chart illustrating a data process in the information processing apparatus according to the present exemplary embodiment. This illustrates in detail, as an example of step S4-4 illustrated in FIG. 5, a process for determining whether to perform equal-magnification and scaling printing from information about the printing area, the size of the printing paper, and the print purpose.

In step S7-1, the equal-magnification and scaling determination unit 3-4 determines whether an output corresponding to the DirectPrint is desired. If the equal-magnification and scaling determination unit 3-4 determines that the output corresponding to the DirectPrint is desired (YES in step S7-1), in step S7-2, the equal-magnification and scaling determination unit 3-4 determines that the equal-magnification printing is performed, and the processing ends. In the present exemplary embodiment, it is determined that the equal-magnification printing is performed. However, a default value set in the printer selected as an output destination may be used.

If the equal-magnification and scaling determination unit 3-4 determines that the output corresponding to the DirectPrint is not desired (NO in step S7-1), in step S7-3, the equal-magnification and scaling determination unit 3-4 determines whether the printing area is equal to the size of the printing paper. If the equal-magnification and scaling determination unit 3-4 determines that the printing area is equal to the size of the printing paper (YES in step S7-3), the process proceeds to step S7-2. The equal-magnification and scaling determination unit 3-4 determines that the equal-magnification printing is performed, and the process ends.

If the equal-magnification and scaling determination unit 3-4 determines that the printing area is not equal to the size of the printing paper (NO in step S7-3), in step S7-4, the equal-magnification and scaling determination unit 3-4 determines whether the printing area is larger than the size of the printing paper. If the equal-magnification and scaling determination unit 3-4 determines that the printing area is larger than the size of the printing paper (YES in step S7-4), in step S7-5, the equal-magnification and scaling determination unit 3-4 determines that reduction printing is performed, and the process ends.

If the equal-magnification and scaling determination unit 3-4 determines that the printing area is not larger than the size of the printing paper (NO in step S7-4), in step S7-6, the equal-magnification and scaling determination unit 3-4 determines that enlargement printing is performed, and the process ends.

Whether the output corresponding to the DirectPrint is desired may be determined from the information transferred from the client computer 1-2 or the mobile terminal 1-4 to the Web application server group 1-5 at the time of printing. For example, “output corresponding to DirectPrint” may be written as setting. Determination can also be made from the destination of input.

For example, if the printing apparatus 1-3 inputs rendering data to the Web application server group, the user directly inputs the rendering data to the printing apparatus using a USB memory and others. The printing apparatus sends the rendering data directly to the Web application server group or via a Device server, which seems to intend the DirectPrint as processing.

The process for automatically determining the printing area and the size of the printing paper is ended as described above. Instead of the Web application server group, the above process is similarly feasible in the printer. The above process is also feasible in an application at a cloud computing. The above process is executed in units of pages, and thereby, it is possible to determine the printing area and the size of the printing paper in units of pages.

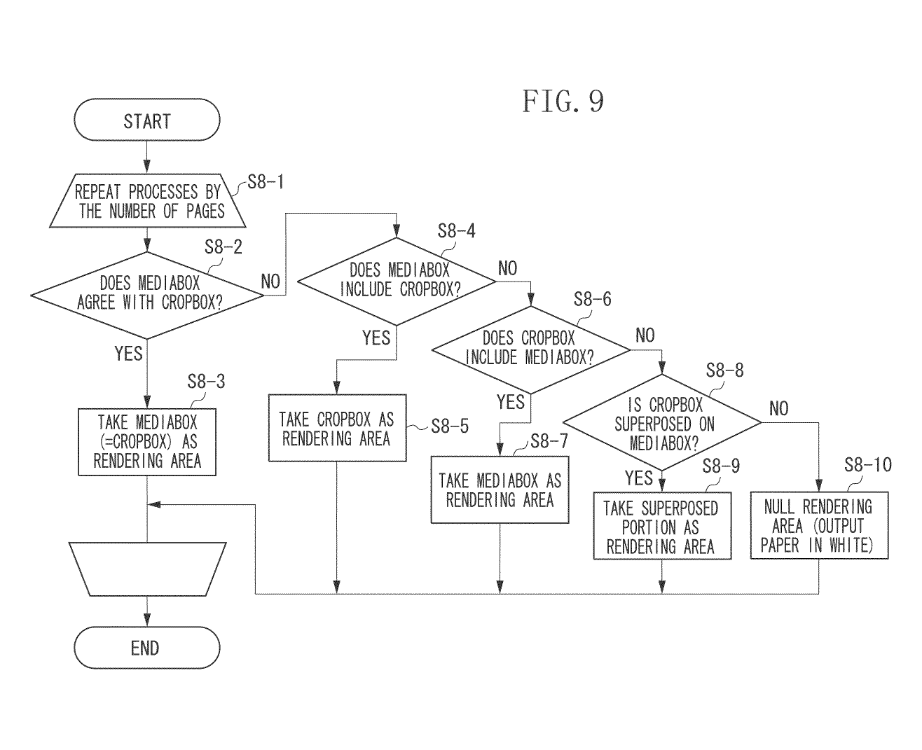

FIG. 9 is a flow chart illustrating a data process in the information processing apparatus according to a second exemplary embodiment. This example illustrates a process for determining other printing areas in step S4-2. The CPU 1 of the server apparatus illustrated in FIG. 3 loads the module illustrated in FIG. 4 into the memory 2 and execute to realize each step. The above process will be described below with the module illustrated in FIG. 4 as a main subject. In the present exemplary embodiment, the printing area determination unit 3-2 determines the printing area from information about a positional relationship between the MediaBox MB and the CropBox CB.

In step S8-1, the following processes are repeated number times corresponding to the number of pages. In step S8-2, the printing area determination unit 3-2 determines whether the MediaBox MB agrees with the CropBox CB. If the printing area determination unit 3-2 determines that the MediaBox MB agrees with the CropBox CB (YES in step S8-2), in step S8-3, the printing area determination unit 3-2 determines the MediaBox (=CropBox) as the rendering area.

If the printing area determination unit 3-2 determines that the MediaBox MB does not agree with the CropBox CB (NO in step S8-2), in step S8-4, the printing area determination unit 3-2 determines whether the MediaBox MB includes the CropBox CB. If the printing area determination unit 3-2 determines that the MediaBox MB includes the CropBox CB (YES in step S8-4), in step S8-5, the printing area determination unit 3-2 determines the CropBox as the printing area. This is because the CropBox can be used as a clip and a portion finally desired as a printed matter is contents of the CropBox.

If the printing area determination unit 3-2 determines that the MediaBox MB does not include the CropBox CB (NO in step S8-4), in step S8-6, the printing area determination unit 3-2 determines whether the CropBox CB includes the MediaBox MB. If the printing area determination unit 3-2 determines that the CropBox CB includes the MediaBox MB (YES in step S8-6), in step S8-7, the printing area determination unit 3-2 determines the MediaBox as the printing area. This method is useful for a case of an application in which the printing area is made larger than a paper size to allow printing even onto a photographic edge when no-edge printing is performed in photo printing. That is, the CropBox which is larger than the MediaBox is taken as the printing area to allow appropriately no-edge printing.

If the printing area determination unit 3-2 determines that the CropBox CB does not include the MediaBox MB (No in step S8-6), in step S8-8, the printing area determination unit 3-2 determines whether the CropBox CB is superposed on the MediaBox MB. If the printing area determination unit 3-2 determines that the CropBox CB is superposed on the MediaBox MB (YES in step S8-8), in step S8-9, the printing area determination unit 3-2 determines the superposed portion as the printing area. This prevents an unintended area from being output.

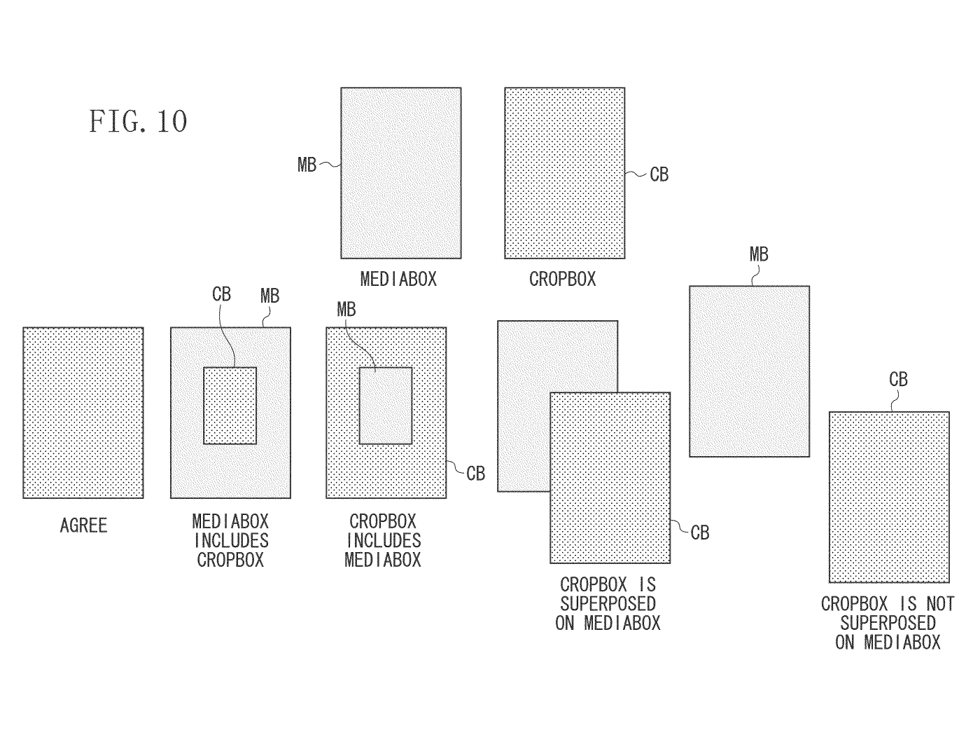

If the printing area determination unit 3-2 determines that the CropBox CB is not superposed on the MediaBox MB (NO in step S8-8), in step S8-10, the printing area determination unit 3-2 nulls the printing area (outputs paper in white) to avoid wasteful printing. FIG. 10 illustrates a positional relationship between the MediaBox MB and the CropBox CB.

The process in FIG. 9 is performed on each page included in the rendering data, and thereby it is possible to determine the printing area in units of pages.

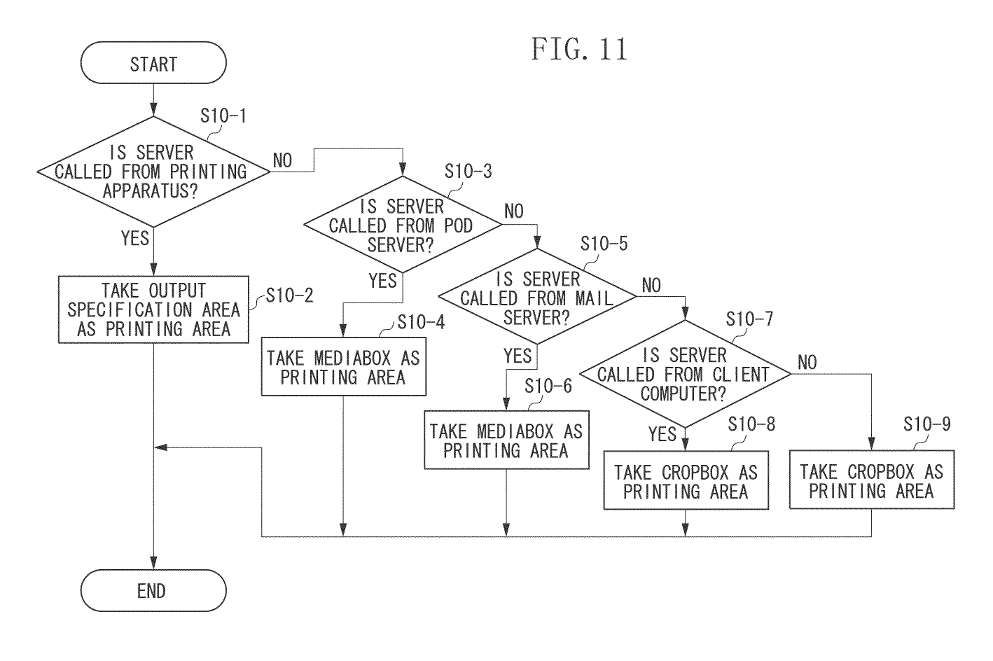

FIG. 11 is a flow chart illustrating a data process in the information processing apparatus according to a third exemplary embodiment. This example illustrates a process for determining other printing areas in step S4-2. The CPU 1 of the server apparatus illustrated in FIG. 3 loads the module illustrated in FIG. 4 into the memory 2 and execute to realize each step. The above process will be described below with the module illustrated in FIG. 4 as a main subject.

This example is possible because the purpose of printing can be inferred by the application service 1-6 of a caller. The purpose of printing means the POD, office, Mobile/Mailprint, and DirectPrint which determine the printing area. The application service includes a Device server, a POD server, a mail server, and an office server.

In step S10-1, if the printing area determination unit 3-2 determines that the Web application server group 1-5 is called by the printing apparatus 1-3, in step S10-2, the printing area determination unit 3-2 determines an output specification area as the printing area. If the determination is negative (NO in step S10-1), in step S10-3, the printing area determination unit 3-2 determines whether the Web application server group 1-5 is called by the application service 1-6 that operates as the POD server. If the determination is positive (YES in step S10-3), in step S10-4, the printing area determination unit 3-2 determines the MediaBox as the printing area. In the POD application, additional information such as a register mark is probably included as the rendering data, outside the CropBox. For this reason, the MediaBox is taken as the printing area to print also such additional information.

If the determination is negative (NO in step S10-3), in step S10-5, the printing area determination unit 3-2 determines whether the Web application server group 1-5 is called by the application service 1-6 that operates as the mail server. If the determination is positive (YES in step S10-5), in step S10-6, the printing area determination unit 3-2 determines the MediaBox as the printing area. In mail, the rendering data received from somebody else, for example, may be printed. In this case, somebody may describe as the rendering data some additional information in the area of the CropBox, so that the MediaBox is determined as the printing area to print the rendering data outside the CropBox.

If the determination is negative (NO in step S10-5), in step S10-7, the printing area determination unit 3-2 determines whether the Web application server group 1-5 is called by the client computer 1-2. If the determination is positive (YES in step S10-7), in step S10-8, the printing area determination unit 3-2 determines the CropBox CB as the printing area. In instructions for printing from the client computer, it is the user operating the client computer that most probably instructs the apparatus to print the rendering data produced by itself. In that case, the user most probably includes the data required for printing among the rendering data produced by itself in the CropBox area. Therefore, the CropBox is determined as the printing area.

If the determination is negative (NO in step S10-7), in step S10-9, the printing area determination unit 3-2 determines the CropBox CB as the printing area. In step S10-7 and the subsequent steps, at any rate, the CropBox CB is selected as the printing area, so that the process in step S10-7 may be omitted.

A print purpose can be determined by the above mentioned process from a source of instructions for printing, so that the printing area adapted for the print purpose can be determined.

In the exemplary embodiments, an output destination, a positional relationship between the MediaBox and the CropBox, and a print purpose are individually used for determining the printing area. However, by weighting these factors, a determination can be comprehensive performed. The following describes an exemplary embodiment of the above.

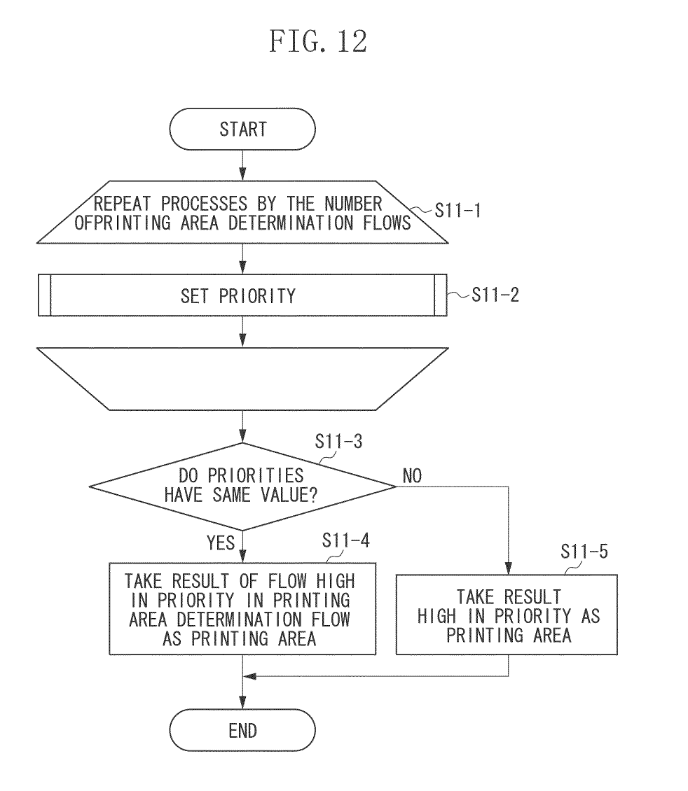

FIG. 12 is a flow chart illustrating a data process in the information processing apparatus according to a fourth exemplary embodiment. This example illustrates a process for determining other printing areas in step S4-2.

In step S11-1, the printing area determination unit 3-2 repeats printing area determination processes using the output destination, the positional relationship between the MediaBox and the CropBox, and the print purpose by the number of printing area determination flows. In step S11-2, the printing area determination unit 3-2 performs the weighting of priority of the printing area at each flow.

In step S11-5, the printing area determination unit 3-2 selects a printing area higher in priority according to the results of the weighting and the process ends.

In step S11-3, the printing area determination unit 3-2 determines that the priorities are equal to each other, in step S11-4, the printing area determination unit 3-2 selects a printing area higher in priority wbetween predetermined items a and the process ends. For example, it is preferable to prioritize the output destination to select the printing area determined by the output destination.

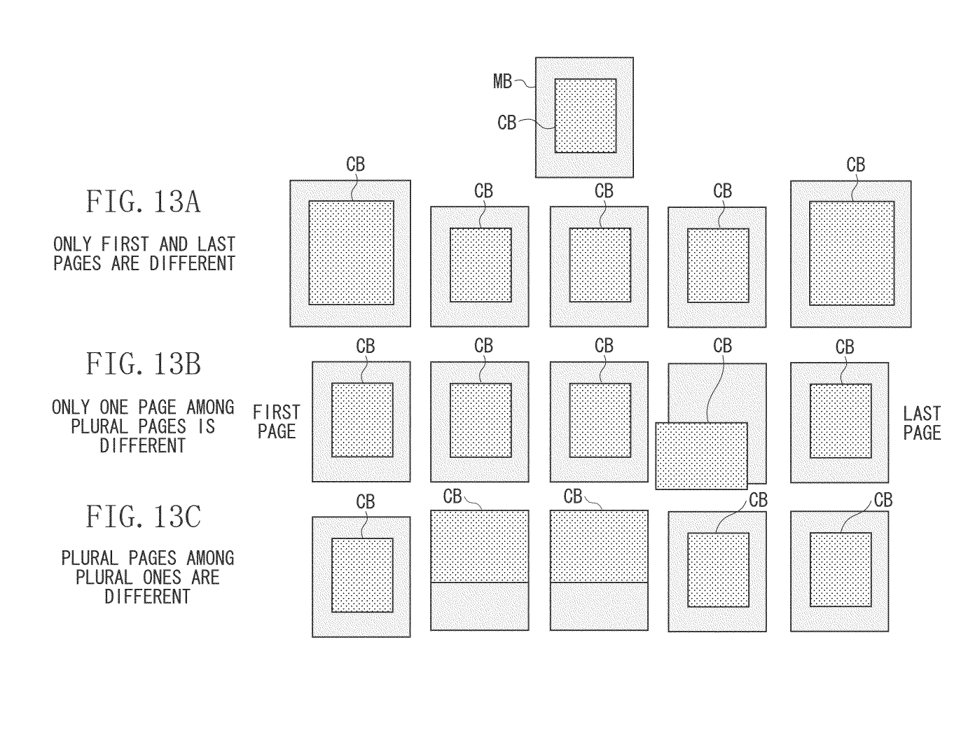

FIGS. 13A, 13B, and 13C are diagrams illustrating a process for determining the printing area in the information processing apparatus according to the present exemplary embodiment. This example is the one that employs the process for determining the printing area in units of pages. More specifically, in the example, units of employing the printing area are switched according to setting information about front and back pages.

As illustrated in FIG. 13A, if only the first and last pages are different from the other pages, the printing area determination unit 3-2 can determine that the pages are intended for covers. In this case, the printing area determination unit 3-2 prioritizes the MediaBox for the first and last pages different in setting.

As illustrated in FIG. 13B, if only one page is different from the other pages, the printing area determination unit 3-2 can determine that an error may occur in setting. In this case, the printing area determination unit 3-2 performs the same setting over the total pages according to the setting of the first and last pages. This brings about the effect of removing the setting error. As illustrated in FIG. 13C, if a plurality of pages is different in setting from the other pages, the printing area determination unit 3-2 can determine that the user intends to perform setting. In this case, the printing area determination unit 3-2 employs the process in units of pages.

Each step of the present invention can be realized by a processing apparatus (CPU or processor) such as a personal computer executing software (program) acquired via a network or various storage media.

The present invention is not limited to the above-described exemplary embodiments, but various modifications (including organic combination of each exemplary embodiment) may be made based on the gist of the present invention and are not excluded from the scope of the present invention.

According to the present invention, even if data that does not identify print setting is received, the printing area and the printing size desirable for the print form can be automatically determined for the data.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-254749 filed Dec. 10, 2013, which is hereby incorporated by reference herein in its entirety.

What is claimed is:

1. An information processing apparatus comprising:
a reception unit configured to receive data on which a printing area and a paper area different from the printing area are set;
an identification unit configured to identify a type of an apparatus for printing the data received by the reception unit; and
a determination unit configured to determine a paper size used for printing using the printing area or the paper size used for printing using the paper area based on the identified type of the printing apparatus.

2. The information processing apparatus according to claim 1, wherein the identification unit identifies in units of pages included in the data whether to use the printing area or the paper area as a printing area based on a positional relationship between the printing area and the paper area, and
the information processing apparatus further comprises a generation unit configured to generate printing data based on the identified printing area.

3. The information processing apparatus according to claim 1, wherein, if the type of the printing apparatus identified by the identification unit is the type that can execute a cutting-out function, the determination unit determines the paper size using the paper area.

4. The information processing apparatus according to claim 1, wherein, if the type of the printing apparatus identified by the identification unit is not the type that can execute a cutting-out function, the determination unit determines the paper size using the printing area.

5. A control method comprising:
receiving data on which a printing area and a paper area different from the printing area are set;
identifying a type of an apparatus for printing the data received; and
determining a paper size used for printing using the printing area or the paper size used for printing using the paper area based on the identified type of the printing apparatus.

6. The control method according to claim 5, wherein the identifying identifies in units of pages included in the data whether to use the printing area or the paper area as a printing area based on a positional relationship between the printing area and the paper area, and the control method further comprises generating printing data based on the identified printing area.

7. The control method according to claim 5, wherein if the type of the printing apparatus identified is the type that can execute a cutting-out function, the determining determines the paper size using the paper area.

8. The control method according to claim 5, wherein, if the type of the printing apparatus identified by the identifying is not the type that can execute cutting, the determining determines the paper size using the printing area.

9. A non-transitory recording medium storing a program for causing a computer to execute:
receiving data on which a printing area and a paper area different from the printing area are set;
identifying a type of an apparatus for printing the data received; and
determining a paper size used for printing using the printing area or the paper size used for printing using the paper area based on the identified type of the printing apparatus.
